(19) United States
(12) Patent Application Publication
(10) Pub. No.: US 2009/0327129 A1
(43) Pub. Date: Dec. 31, 2009

(54) SOCIAL NETWORK ENABLED GROUP GIFT CARD

(75) Inventors: James Collas, San Diego, CA (US); Chris Nicolaidis, Carlsbad, CA (US); Jonathan Shultz, Jamul, CA (US); Jeffery Hall, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: IDEAEDGE, INC., San Diego, CA (US)

(21) Appl. No.: 12/403,245

(22) Filed: Mar. 12, 2009

Related U.S. Application Data
(60) Provisional application No. 61/035,965, filed on Mar. 12, 2008.

(51) Int. Cl. G06Q 40/00; G06F 15/16; G06Q 20/00

(52) U.S. Cl. 705/41; 709/204

(57) ABSTRACT

A system and method that allows for a group of individuals to easily contribute to the same gift card is disclosed. The gift card can be a traditional physical card or an electronic card. In one embodiment, an account administrator establishes a group enabled gift card account for self-consumption or for a specified gift recipient. The administrator engages potential group gift card contributors through various electronic communication mechanisms who can then add funds to the account. The contribution period may remain open based on criteria supplied by the administrator. Once the account is closed, the collected amount is transferred to a designated gift card and sent to the recipient.

### RELATED APPLICATION

This application claims the benefit of U.S. Provisional Patent Application Ser. No. 61/035,965, filed Mar. 12, 2008, entitled “Social Network Enabled Group Gift Card” which is hereby incorporated by reference in its entirety.

### FIELD OF THE INVENTION

This invention relates generally to stored value cards, and more particularly to stored value cards having a plurality of contributors.

### BACKGROUND

Stored-value cards and other financial transactions cards come in many forms. A gift card, for example, is a type of stored-value card that includes pre-loaded or selectively loaded monetary value. In one example, a customer buys a gift card having a specified value for presentation as a gift for another person. In another example, a customer is offered a gift card as an incentive to make a purchase. A gift card, like other stored-value cards, can be “recharged” or “reloaded” at the direction of the bearer. The balance associated with the card declines as the card is used, encouraging repeat visits to the retailer or other provider issuing the card.

Gift cards can come in two forms—traditional, credit-card style and electronic email versions. For a traditional gift card, the card includes and account identifier associated with a physical card and generally remains in the user's purse or wallet, serving as an advertisement or reminder to revisit the associated retailer. For an electronic gift card, the card is merely an account identifier without the use of a physical card.

Electronic gift cards can be redeemed online similar to traditional, credit-card style gift cards and provide a number of advantages to both the consumer and the retailer. As online shopping has grown, so has the electronic gift card industry. This can be attributed in part to the preference of customers for electronic gift cards, the ease at which they may be used, and the fact that they are not easily lost or misplaced like their traditional counterparts.

While gift cards may be purchased by a single customer and sent as a gift for another person, there currently does not exist a method/system that allows multiple people to pledge specific contributions to a single gift card and send as a gift for another person.

### SUMMARY

Described herein is a system and method that allows for a group of individuals (referred to herein as a “social network”), such as friends, family and colleagues, to easily contribute to the same gift card. The gift card can be a traditional physical card or an electronic card.

Generally, an account administrator establishes a group enabled gift card account for self-consumption or for a specified gift recipient. The administrator engages potential group gift card contributors through various electronic communication mechanisms who can then add funds to the account. The contribution period remains open based on criteria supplied by the administrator. Once the account is closed, the collected amount is transferred to a designated gift card and sent to the recipient.

In one embodiment, a method for contributing to a group gift card includes initiating a group gift card account, soliciting potential contributors from a first potential contributor list to financially contribute to the group gift card account, receiving a financial contribution from a first contributor to the group gift card account, soliciting potential contributors from a second potential contributor list to financially contribute to the group gift card, and receiving a financial contribution from a second contributor to the group gift card account.

In another embodiment, a method for operating a group gift card system in a social networking system includes initiating a group gift card account, identifying a first potential contributor list from a first social group list of a personalized data set of the group gift card recipient, transmitting an electronic communication to a first party on the first social group list via an electronic communication pathway, prompting the first party to make a financial contribution to the group gift card account, acquiring a second potential contributor list from a second social group list of a personalized data set of the first party, transmitting an electronic communication to a second party on the second social group list via an electronic communication pathway, prompting the second party to make a financial contribution to the group gift card account and receiving an electronic payment from at least two parties on the social group lists to fund the group gift card account.

In yet another embodiment, a system for managing a group gift card includes an account administration module configured to create a group gift card account, a gift card contribution module configured to receive financial contributions from at least two contributors to the group gift card account, and a gift card distribution module configured to distribute a gift card to a recipient after the group gift card account has been closed. The group gift card account has close date associated with it. Also, the financial contributions to the group gift card are obtained by electronically communicating with potential contributors on a social group list and requesting the financial contributions.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram representation of a collection of computer systems which can interact with each other, according to an embodiment.

FIG. 2 is a block diagram representation of modules or functionality which can be implemented by the system 20 shown in FIG. 1.

FIG. 3 is a block diagram representation of sub-modules or functionality which can be implemented by the modules of FIG. 2.

FIG. 4 is a block diagram representation of a collection of computer systems which can interact with each other, according to an embodiment.

FIGS. 5-16 are exemplary screen shots of a group gift card initiation and propagation session, according to an embodiment.

### DETAILED DESCRIPTION

After reading this description, it will become apparent to one skilled in the art how to implement the invention in various alternative embodiments and alternative applications. The following description sets forth numerous specific details, such as examples of specific systems, components and methods in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Particular implementations may vary from these exemplary details and still be contemplated to be within the spirit and scope of the present invention.

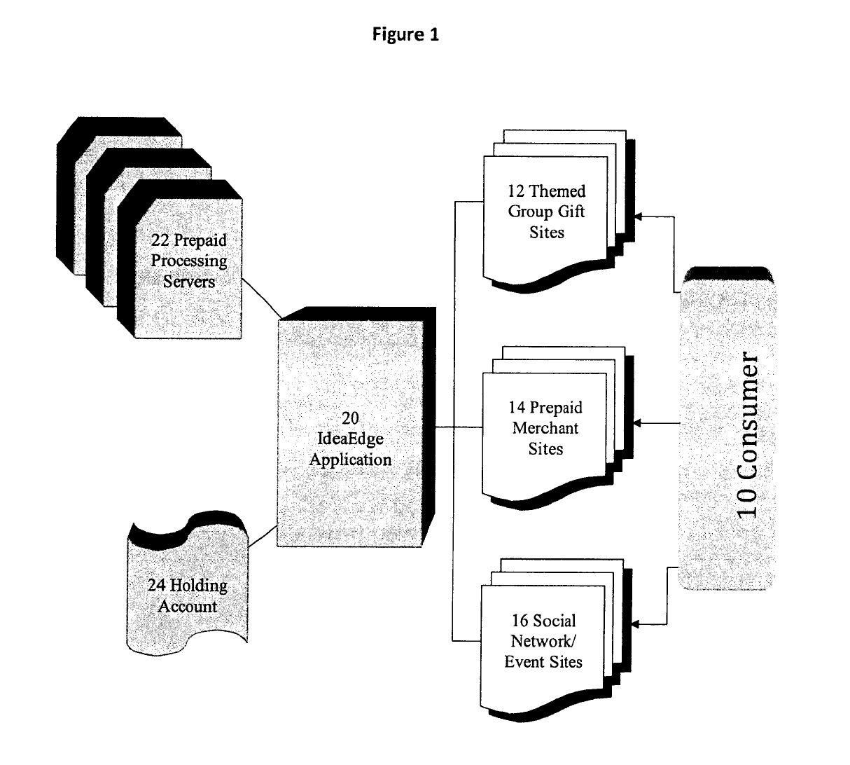

Turning now to FIG. 1, a block diagram representation of a collection of computer systems which can interact with each other by a connection, such as the Internet, local area networks, wide area networks, virtual private networks, and direct connections is shown. Each of the blocks shown in FIG. 1 represents a computer system, such as a server, a personal computer or other devices capable of communicating over the connections, or a collection of such devices and are generally referred to herein as devices.

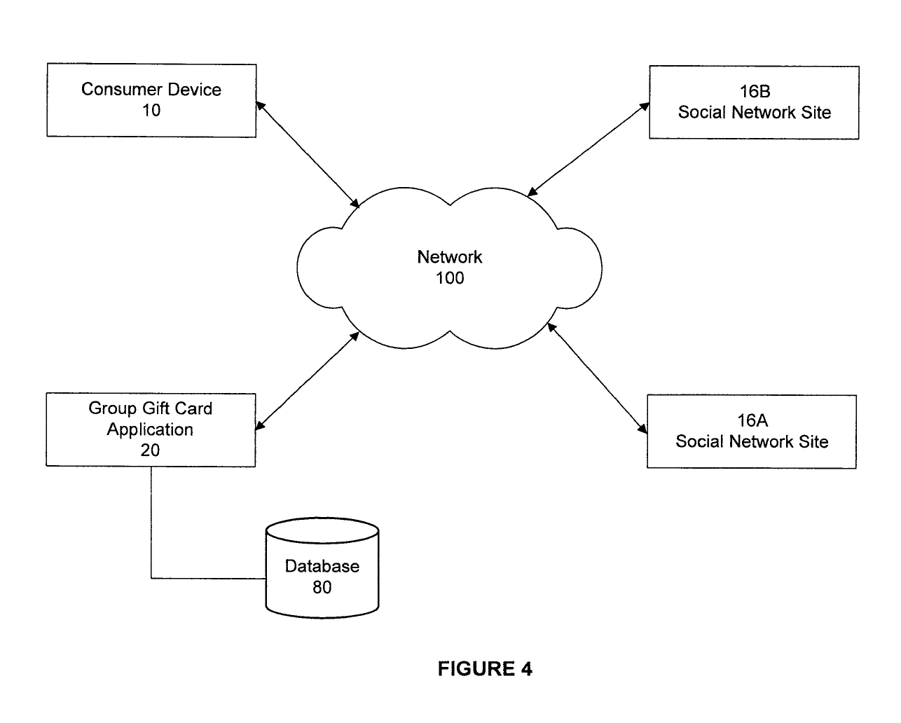

In general, block 10 represents a network device of a consumer or user of the system. Device 10 can represent an account administrator, a recipient and a contributor. The device 10 can be any network device. In general, the device 10 is a machine with the ability to communicate with one or more of the computer systems depicted in FIG. 1. For example, in one embodiment, the device 10 is a personal computer with a network connection such as an Internet connection or a wireless device with access to a wireless network such as a mobile telephone or a personal digital assistant. An exemplary network 100 is shown in FIG. 4. In one embodiment, the device 10 communicates with devices 12, 14 and 16 via a web browser.

Blocks 12, 14 and 16 each represent one or more computer systems which provide the interactive functionality of a website as is generally known in the art. Each of these systems or devices 12, 14 and 16 provide web pages which can be visited by consumers or customers to provide the information necessary to initiate a gift card, which can receive contributions from a social network.

A social network, as used in connection with certain embodiments herein, relies upon a social network service for building online communities of people who share interests and/or activities, or who are interested in exploring the interests and activities of others. Such social network services are web based and provide a variety of ways for users to interact, such as email and instant messaging services.

In general, social networking services allow users to create a profile for themselves, and can be broken down into two broad categories: internal social networking (“ISN”) and external social networking (“ESN”) sites, such as MySpace, Facebook, etc. Both types can increase the feeling of community among people. An ISN is a closed/private community that consists of a group of people within a company, association, society, education provider and organization or even an “invite only” group created by a user in an ESN. An ESN is open/public and available to all web users to communicate and are designed to attract advertisers. ESN's can be smaller specialized communities (e.g., linked by a single common interest) or they can be large generic social networking sites (e.g., MySpace, Facebook etc).

However, whether specialized or generic there is commonality across the general approach of social networking sites. Users can upload a picture of themselves, create their ‘profile’ and can often be “friends” with other users. In many social networking services, both users must confirm that they are friends before they are linked. Some social networking sites have a “favorites” feature that does not need approval from the other user. However, social networks usually have privacy controls that allow the user to choose who can view their profile or contact them, etc.

Referring back to FIG. 1, in one embodiment, device 12 represents themed group gift sites. Examples of themed group gift sites represented by device 12 include giftcertificates.com and giftcardmall.com.

In one embodiment, device 14 represents pre-paid merchant sites. Examples of pre-paid merchant sites represented by device 14 include the web sites of retailers such as Nordstrom's and Toys R Us.

In one embodiment, device 16 represents social networks/events sites. Examples of social networks/events sites represented by device 16 include Myspace, Facebook, Evite, and Crusher. As explained above, these sites allow users to create a profile for themselves and create a sense of community among other users and visitors. Users typically can personalize their social networking site by uploading pictures, personalizing content and linking to friends who also have an account with the service.

According to one aspect, block 20 represents a computer system or device which provides the back-end functionality for gift card setup, management and funding. Alternatively, that functionality can be provided directly on computer systems 12, 14 and 16.

In one embodiment, system 20 interacts with block 22 to create desired accounts. Block 22 represents the computer systems or devices of one or more companies which implement gift card systems. The computer system 22 issues or creates the appropriate accounts and their corresponding account identifiers for the gift cards. Generally, an account contains information and parameters specific for the gift card system offering. The parameters can contain, for example, a password, a face value of the gift card offering and a field indicating whether the account has been activated. The account corresponding to an account identifier is typically activated at the time the gift card system is purchased (pre-paid).

In one aspect, an account identifier cannot be redeemed or utilized to make a purchase until it is activated. Consumers (recipients) can use this account identifier as a form of payment at merchant retail stores (as a physical gift card) and online websites (as an electronic gift card or physical gift card) where accepted. Such companies and systems are well known to those of ordinary skill in the art.

In one embodiment, system 20 interacts with block 24 to create hold accounts. In an example, block 24 represents a holding account system. Use of a holding account is desirable in some instances, such as when pre-paid gift card system 22 has a fee per funding transaction. In such instances, funds from various contributors to a gift card can be held in the holding account system 24 until a pre-determined or selected level is reached. At that time, a single funding event or transaction with the pre-paid processing service 22 can take place, thereby avoiding a charge on each of the individual contributions.

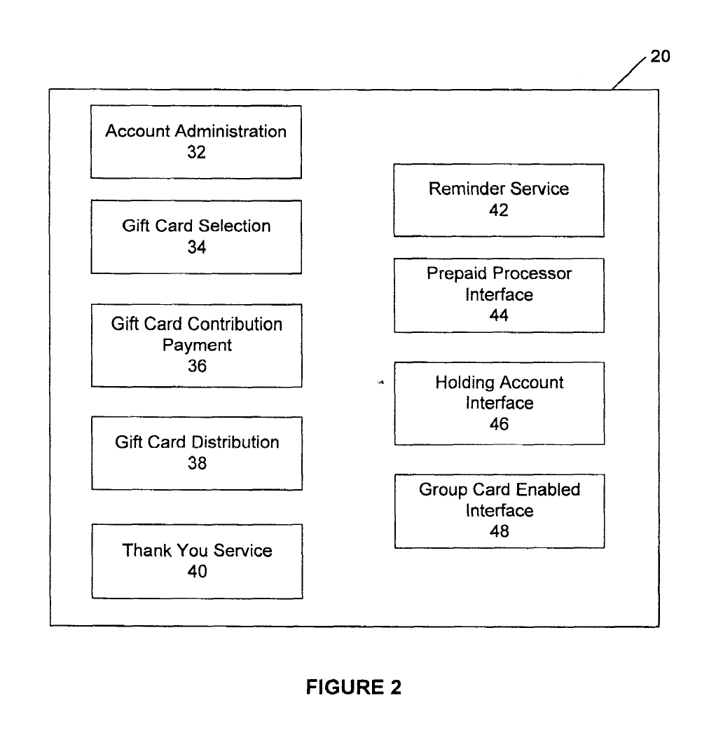

As stated above, system 20 provides back-end functionality for gift card setup, management and funding. FIG. 2 shows a block diagram representation of the modules or functionality which can be implemented by the system 20. These modules may hereinafter be collectively referred to as “group gift card functionality”. In one embodiment, the modules or functionality implemented by system 20 include account administration module 32, gift card selection module 34, gift card contribution for payment module 36, gift card distribution module 38, thank you service module 40, and reminder service module 42. Additionally, system 20 may include a prepaid processor interface module 44, a holding account interface module 46 and a group card enabled interface module 48.

According to one aspect, account administration module 32 provides the features and tools that allow an account administrator to create and manage an event. As used herein, an event refers to the creation and funding of a gift card. In many instances, an event is associated with a social occasion such as a birthday or a holiday. In one embodiment, an account administrator or host is the individual that initiates the group gift card. For example, an account administrator can be a friend of someone having a birthday or the person having the birthday themselves. Device 10 in FIG. 1 can represent the device of an account administrator through which the account administrator interacts with the systems and modules described herein. Device 10 may also represent a contributor or a recipient, though only one device 10 is depicted.

Alternatively, the functions of the account administrator can be automated so that an event is initiated or created without a host or account administrator. In some embodiments, the system 20 can automatically initiate a group gift card. For example, the system 20 can initiate a group gift card in response to birth dates stored on a social networking page (e.g., Facebook).

Account administration module 32 allows the account administrator to create and manage the event which results in the funding of the gift card. In one embodiment, this module is used by the account administrator to establish and personalize the web page where contributions can be received. A further function of this module is sending invitations to notify potential contributors of the event (e.g., the opportunity to contribute to the gift card). In one embodiment, the notification is done by email with the account administration 32 module generating emails in response to receiving one or more email addresses. The emails can include a link to the web page that is created. In some embodiments, the account administrator interacts with account administration module 32 via first interacting with one of the devices 12, 14 or 16. The interaction can be accomplished by interaction with functionality provided directly by devices 12, 14 or 16 or linkage from devices 12, 14 or 16 to system 20.

In one embodiment, account administration module 32 also collects the name, address, email address, and phone number (and/or other identifying information) of the account administrator and allows them to create an ID and a password. The account administrator may also be presented with the terms and conditions for the use of the service and the account administrator's acknowledgement and agreement to those terms is subsequently recorded. In some embodiments, the module 32 additionally receives and records the recipient's name, address, email address, phone number and the gift card delivery preference. This information can all be provided by the account administrator. Alternatively, the module can generate a communication, such as an email, to the recipient prompting the recipient to provide this information. The module 32 further generates and maintains the status of the event, e.g., active, closed, pending close, the current contribution amount, the event notification preference (e.g., email notices when funds are received from contributors), and a unique ID for the event.

It should be understood that the invitation and propagation components of the account administration module 32 allow the account administrator to enter email addresses (or other electronic contact information) of potential contributors. When the group gift card is automatically initiated, email addresses can be mined from the recipient's contacts associated with their social network page. Additionally, the gift card contribution module allows 36 contributors to add to the list of potential contributors. In some embodiments, for each potential contributor the module 36 requests and records the email address of the contributor, the name of the contributor, a personalized subject line to the email and, if desired a personalize message for the body of the email. The module then generates and transmits email to each of those email addresses. In some embodiments, the account administrator or other donors can also agree to match contributions made by others.

The gift card selection module 34 allows the account administrator to select one or more specific brands or types of gift cards. This functionality also allows the account administrator to select or suggest total gift card amounts. In one embodiment, a fixed range of amounts or fixed amounts for gift cards are predetermined. In another embodiment, the amount of the gift card is not predetermined.

As explained above, in some embodiments, the gift card contribution module 36 receives the information from contributors and performs the processing to accept their contributions. For example, this can be in the form of a credit card transaction. This module 36 also allows the contributors to create and leave personalized greetings in connection with their contribution.

In one embodiment the gift card contribution module 36 allows contributors to select the dollar amount of the contribution. It also allows the contributor to select their payment method, for example, identifying the type of credit card or debit card to be used. This module 36 also collects contributor billing information and payment information. In one embodiment, this module 36 also performs preauthorization of the fund amount of the contributor. For example, this can take the form of a credit card preauthorization transaction. Additionally this module 36 may also complete the fund transaction. In summary, the gift card contribution module 36, in one embodiment, prompts the contributor for and receives and records the contributor's name, billing address, their selected dollar gift contribution amount and their payment method and payment information and a personalized greeting card message.

In some embodiments, prepaid processor interface module 44 establishes the connections and communications for system 20 with the prepaid processing servers 22 of FIG. 1. This module 44 also preferably provides the information to prepaid processing servers 22 in order for them to set up and fund the gift cards.

The holding account interface module or escrow module 46 allows for the holding of contributions from multiple gift card contributors. In one embodiment, the holding account interface module 46 stores gift card contributions received by the gift card contribution module 36 in a temporary holding account until a predetermined event. For example, in one embodiment, the predetermined event is when the account administrator closes the account or record. The account balance of the holding account is subsequently transferred to the prepaid processing servers 22 in a single transaction using the prepaid processor interface module 44. Holding account interface module 46 can also decrement the holding account, for example, when funds are not approved. Additionally, in some embodiments, module 46 can also perform account fund reconciliation.

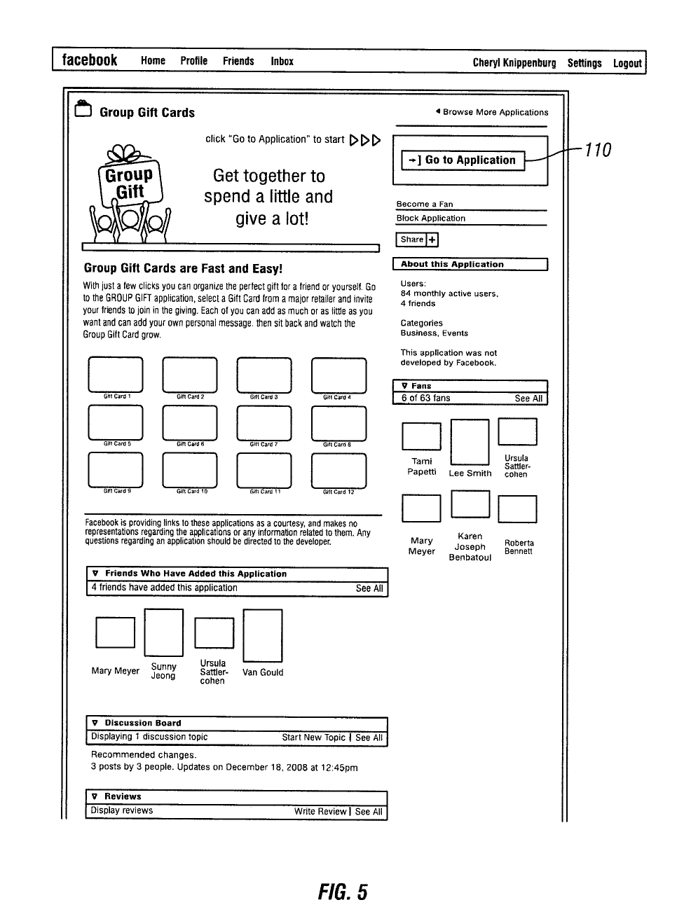

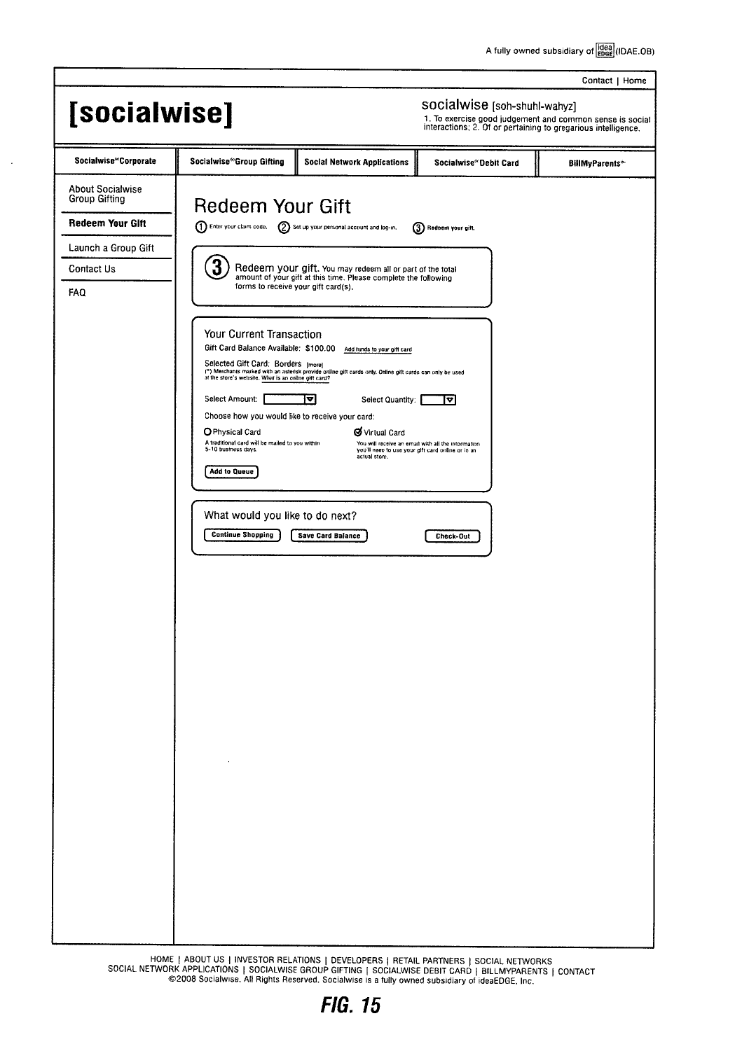

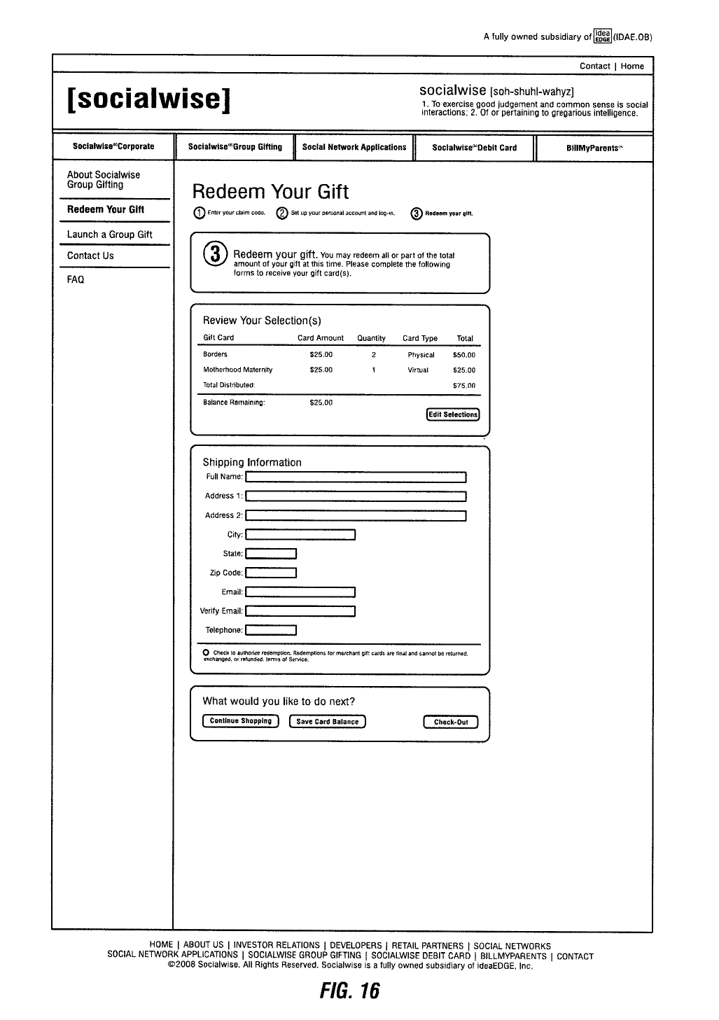

Group card enabled interface module 48 provides interfaces between the various websites (e.g., computer systems represented in FIG. 1 by systems 12, 14 and 16) which utilize the functionality provided by system 20 of FIG. 1. For example, the group card enabled interface module 48 can provide interfaces to social network and event sites (represented by system 16), prepaid gift card merchant sites (represented by system 14) and themed group gift sites (represented by system 12). The interfaces provided by this module vary depending on the type sites with which it is interfacing. For example, social networking site users can download and insert HTML, XML or application code which provides a connection to system 20 of FIG. 1. The HTML, XML or application code preferably conforms to the Application Programming Interface (API) specific to the social networking site of interest. Such code can be made available on a web page provided by system 20. See FIGS. 5-16.

The application code can also allow the social networking site user to pull content or data (e.g., a friend list) from their social networking page into the account administration module. For example, the user or administrator may be a member of a social networking site and first logs in to their personalized social networking account. Saved in the account are a variety of personalized data sets including information such as the user's birth date, and a friends or contacts list which identifies other members of the social network that the member has some connection. The terms “friend list” and “social group list” are hereinafter used interchangeably.

In some embodiments, gift card distribution module 38 distributes a gift card to the recipient after it has been funded. The delivery options can be limited or determined by the type of gift card selected through interaction with the gift card selection module. In one embodiment, the gift card is delivered by mail or electronically. Additionally, module 38 may generate and transmit a greeting card with the names of and messages from the contributors.

Thank you service module 40 allows the recipient to communicate to all the contributors with personalized greeting and thank you messages. In one embodiment, the communications are via email. The email list is preferably generated from email addresses provided by contributors to the gift card contribution module 36.

Reminder service module 42 provides for the storage of information pertaining to an event (gift card contribution) and transmits reminder messages for similar future events. For example, the account administrator and potential contributors associated with a past event may be sent upcoming event reminders for recurring dates such as birthdays, anniversary and holidays that are associated to gift recipients from past events.

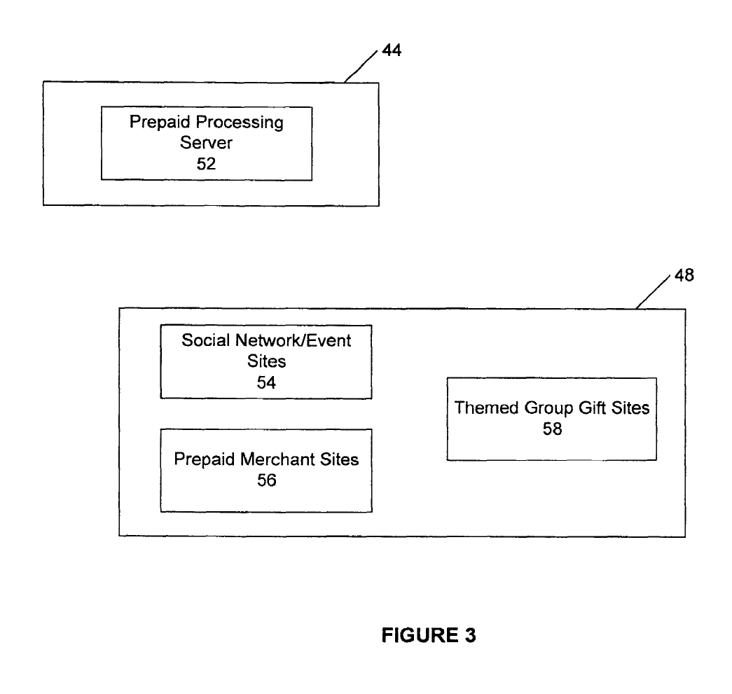

Turning now to FIG. 3, a block diagram of various interface modules or sub-modules which can be included with the modules 32-48 depicted in FIG. 2 is shown. The modules of sub-modules shown in FIG. 3 may be integral to the modules shown in FIG. 2, or they may be separate.

In one embodiment, the prepaid processor interface module 44 of FIG. 2 includes as a sub-module, prepaid processing server interface module 52. In one embodiment, prepaid processing server interface module 52 creates a secure connection between device 20 and prepaid processing server 22 of FIG. 1. Such a secure connection can be made using the protocols required by the operators of the prepaid processing servers. In one embodiment, prepaid processing server interface module 52 further associates the gift cards (e.g., accounts identifiers) generated by the prepaid processing servers 22 with the associated events created by account administrators. This module 52 also preferably interfaces with prepaid processing server 22 to decrement account funds. This module can also validate the status of gift cards (e.g., activated) and their monetary balance. In one embodiment, this validation is in response to queries from the account administrator. The validation may be performed by sending requests and receiving responses from the prepaid processing server 22 of FIG. 1.

Social network/event site interface module 54 provides the interfacing to social networking/event sites (represented by system 16) for the device 20. In one embodiment, this module 54 is a sub-module of the group card enabled interface module 48 of FIG. 2. Social network/event site interface module 54 allows the account administrator to customize the content of the web page for the event. For example, account administrators can personalize the web page by selecting background, colors, fonts, themes, graphics and by adding textual content.

Prepaid merchant site interface module 56 provides a connection between the modules of device 20 with prepaid gift card merchants (represented by device 14) in FIG. 1. Module 56 can be a sub-module of the group card enable interface module 48 of FIG. 2. In one embodiment, account administrators are redirected to device 20 for the group gift card functionality. The redirection may or may not be transparent. In one embodiment, the interfaces provided to the account administrator are customized to be consistent with the look and feel of the prepaid merchant site. Alternatively, the account administrator and contributors interact directly with the prepaid merchant web site which then interacts with device 20 through module 56. In one embodiment, the prepaid merchant web site is framed, enabling the merchant website to display more than one HTML document in the same browser window, which allows the user to view a web page from device 20 within the merchant web site.

Themed group gift site interface module 58 provides a connection between the modules of device 20 with themed gift sites (represented by device 12) in FIG. 1. Themed group gift site interface module 58 can be a sub-module of the group card enable interface module 48 of FIG. 2. In one embodiment, account administrators are redirected to device 20 for the group gift card functionality. The redirection may or may not be transparent. In one embodiment, the interfaces provided to the account administrator are customized to be consistent with the look and feel of the themed group gift site. Alternatively, the account administrator and contributors interact directly with the themed group gift site which then interacts with device 20 through module 58. In one embodiment, the themed group gift web site is framed, enabling the themed group gift web site to display more than one HTML document in the same browser window, which allows the user to view a web page from device 20 within the themed group gift web site

In order to more fully describe the operation and functionality of the group gift card system 20, turning now to FIGS. 5-16, an exemplary group gift card initiation and propagation session will be discussed with reference to screen shots an administrator on device 10 encounters using the social networking site Facebook. Unless otherwise noted, the described operation and functions are carried out by system 20.

Firstly, a user or administrator on device 10 logs onto his/her Facebook page provided by device 16 over network 100. The administrator then has the option to “Go to Application” by clicking on link 110, which directs the administrator to the group gift card application or system 20. Link 110 is shown in FIG. 5.

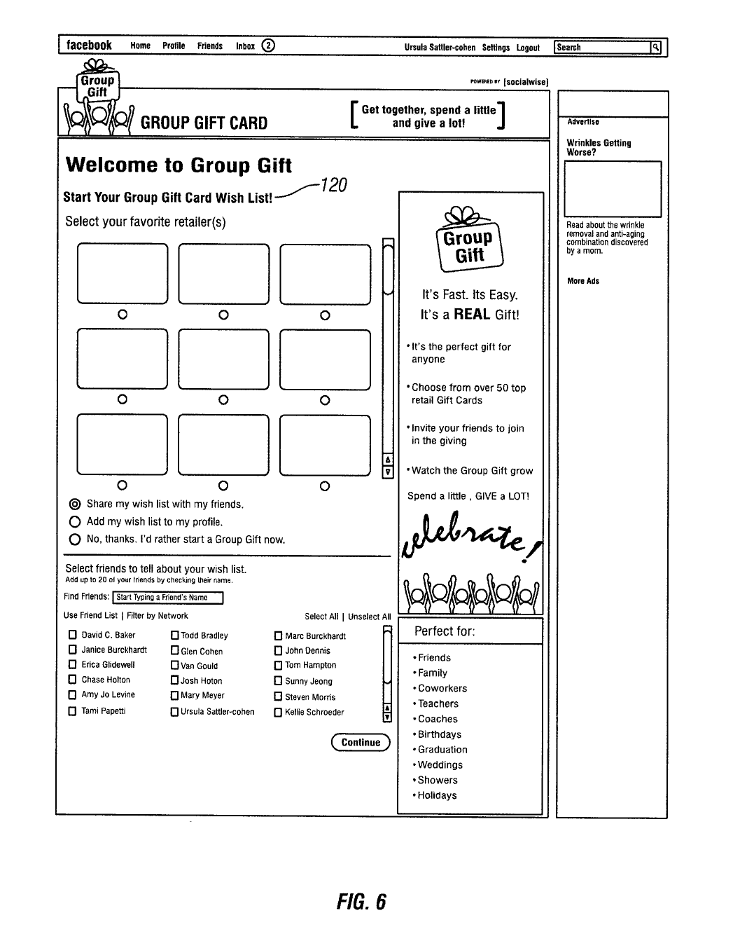

FIG. 6 represents the group gift card home page, where the administrator is prompted to create a group gift card wish list 120 by selecting from a list of popular retailers. The administrator has the option of sharing the wish list with friends or contacts (e.g., from Facebook's friend list), adding the wish list to the administrator's Facebook profile, or bypassing the group gift card wish list and creating a group gift card.

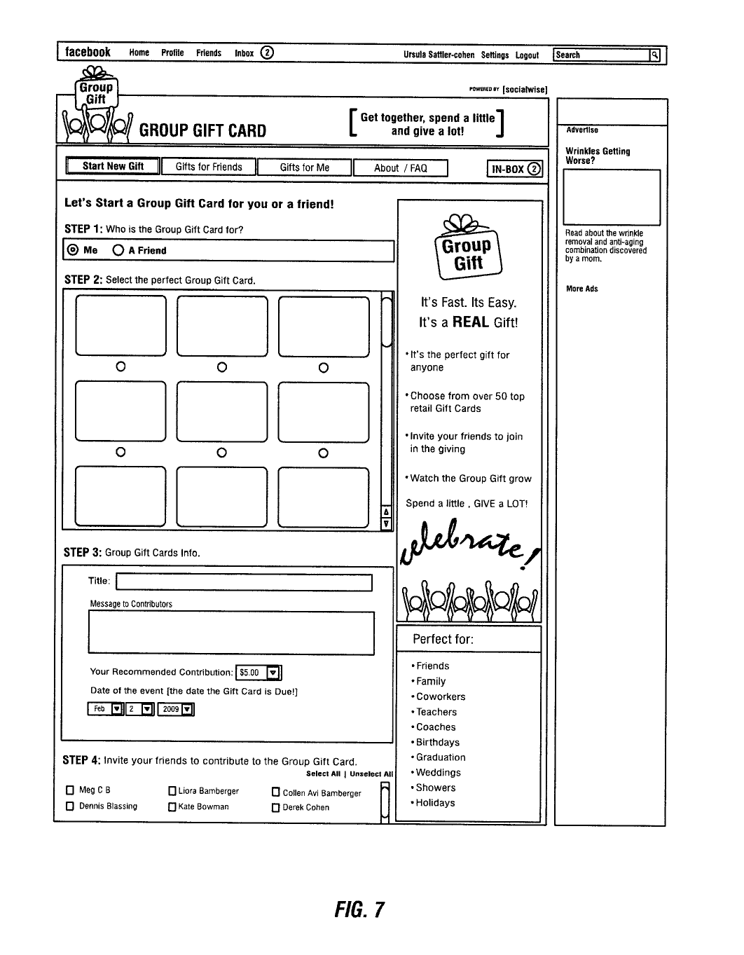

In FIG. 7, the administrator has initiated a group gift card. In step 1, the administrator is prompted to identify if the group gift card is for the administrator or for a friend. In step 2, the administrator is prompted to select the group gift card from a popular list of retailers. In step 3, the administrator is prompted to enter a title, a message to the contributors, a recommended contribution amount, and the date of the event (e.g., the date the gift card is due). In step 4, the administrator is prompted to invite friends (e.g., from Facebook's friend list) to contribute to the newly created group gift card.

By inviting friends to contribute to the newly created gift card, the system 20 transmits an electronic communication to the social group list saved in the user's personal data set via an electronic communication pathway. Each member of the social group list is prompted to financially contribute to the gift card and invite others on their respective social group lists to financially contribute to the gift card. Should a member of the user's social group decide to invite others on that member's social group list, the system transmits an electronic communication to the new social group list, prompting the members to financially contribute to the gift card. In this way, a plurality of social group lists from multiple members' personal data sets can be acquired and utilized to fund the original user's gift card. In an embodiment, such transmission of information is performed according to the social networking site protocol for electronic communication pathways.

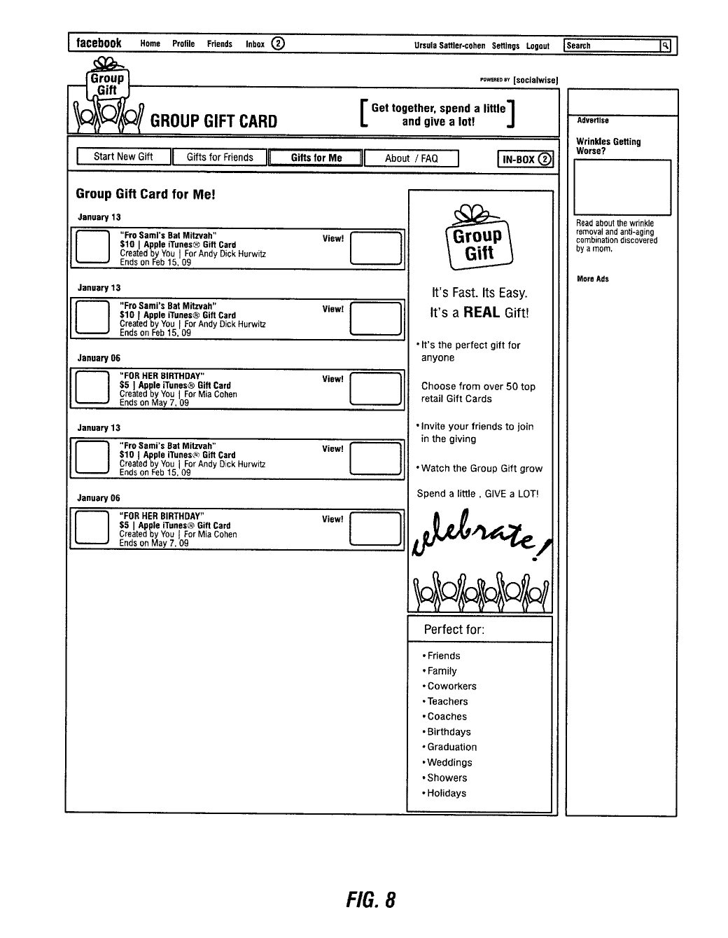

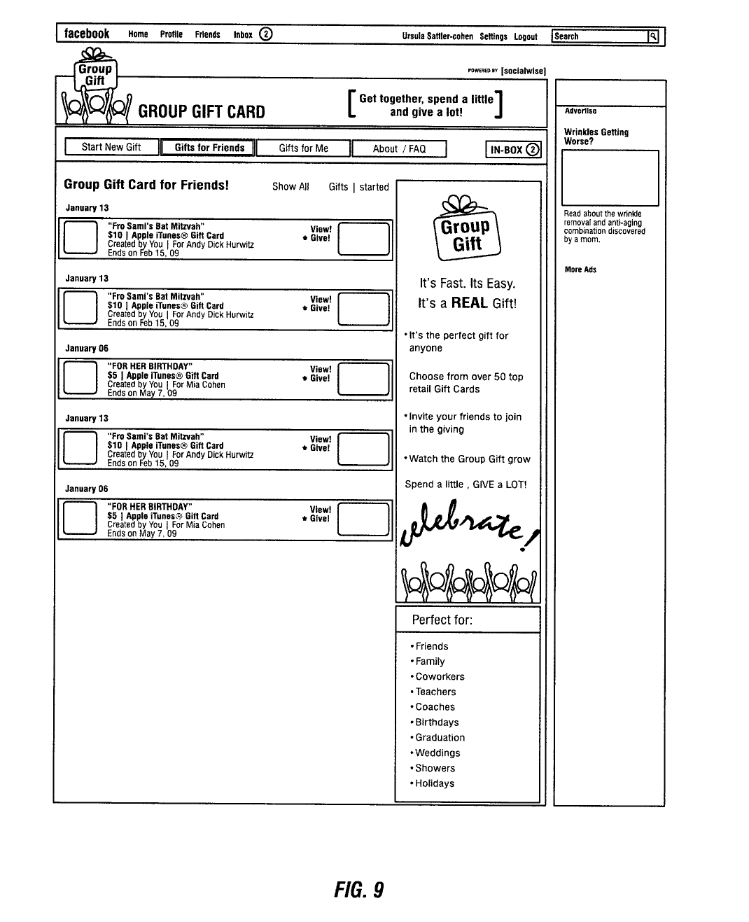

In FIGS. 8 and 9, the administrator can view the list of gift cards created for the administrator (FIG. 8) and for friends (FIG. 9). The administrator can also view individual and contribute to individual gift cards from the list of gift cards.

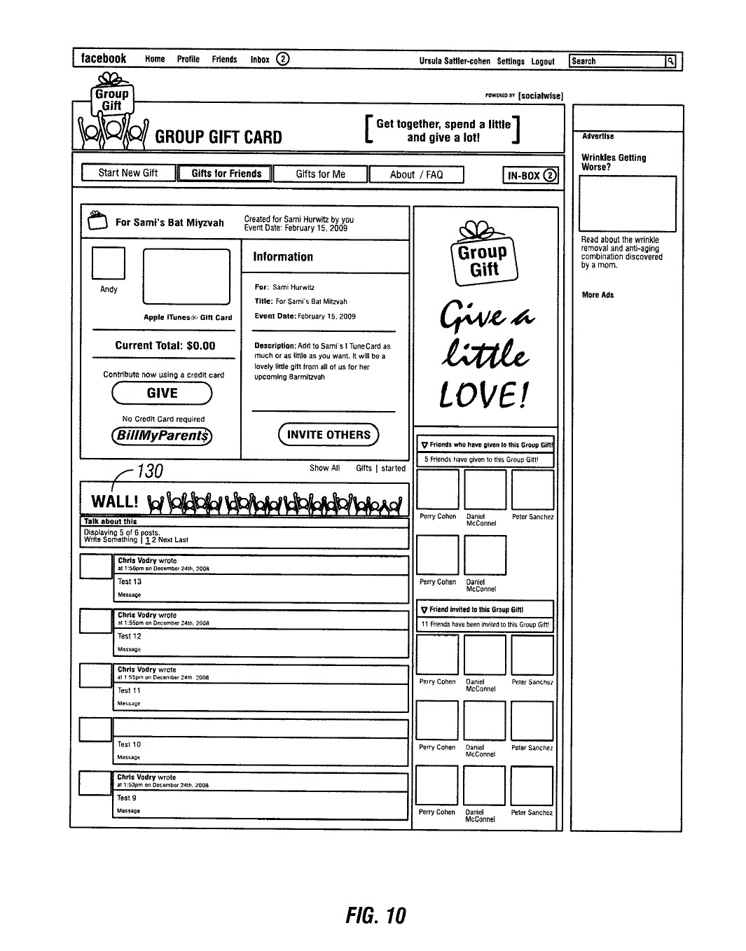

For example, in FIG. 10, the administrator is viewing a gift card for a friend (Sami's Bar Mitzvah's Apple iTunes gift card). The administrator can contribute to the gift card or invite others to give. Additionally, the administrator can write and read posts about the group gift card on the wall message board 130. The administrator may also be able to view the friends that have contributed to the group gift card and view friends that have been invited to contribute to the group gift card.

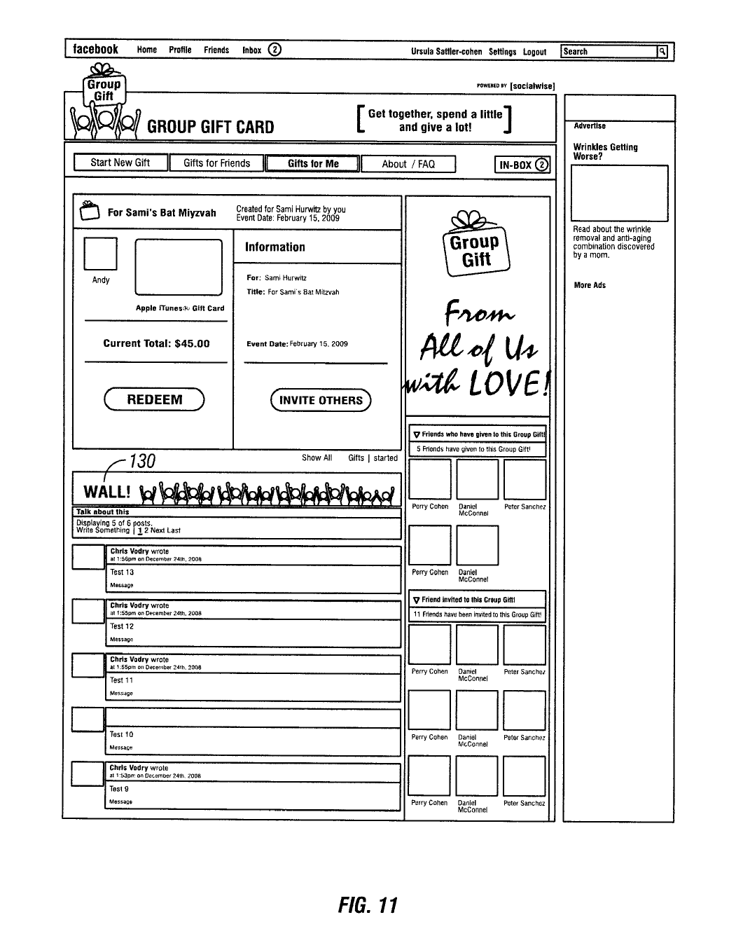

Turning to FIG. 11, the administrator is viewing a group gift card for himself/herself that has a balance of $45.00. The administrator can either redeem the gift card or invite others to contribute. The administrator can also write and read posts about the group gift card on the wall message board 130, view the friends that have contributed to the group gift card and view friends that have been invited to contribute to the group gift card.

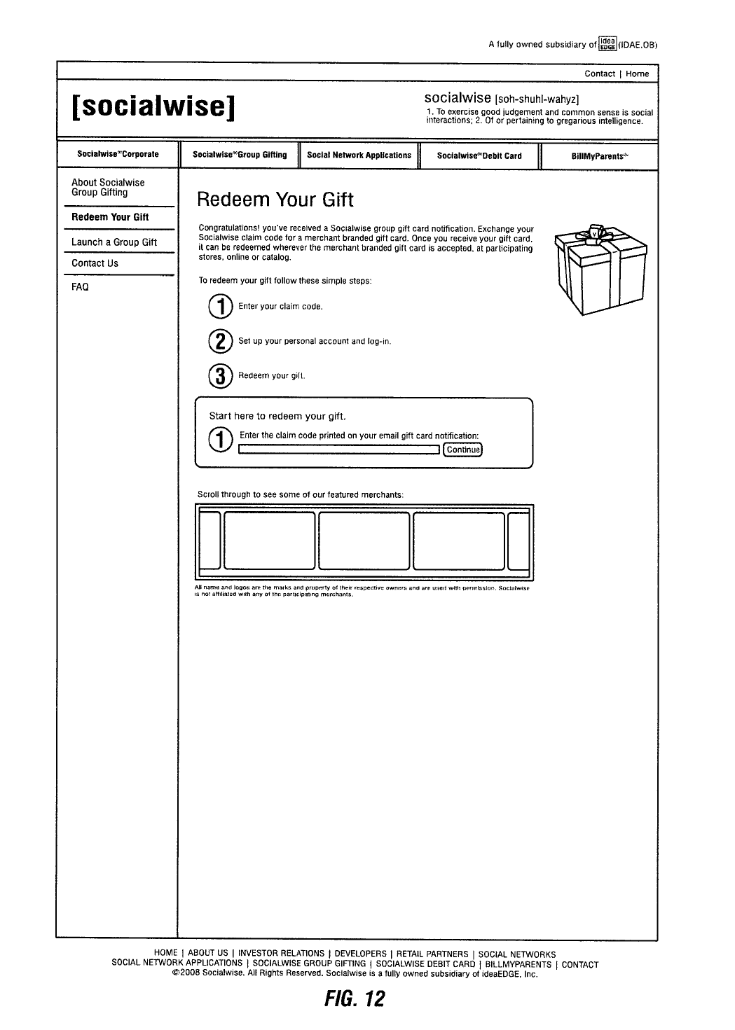

In FIG. 12, the administrator has chosen to redeem a group gift card, by selecting the redeem option, discussed above with respect to FIG. 11. In order to redeem the gift card, in step 1, the administrator must enter a claim code. The claim code may have been emailed to the administrator by gift card distribution module 38.

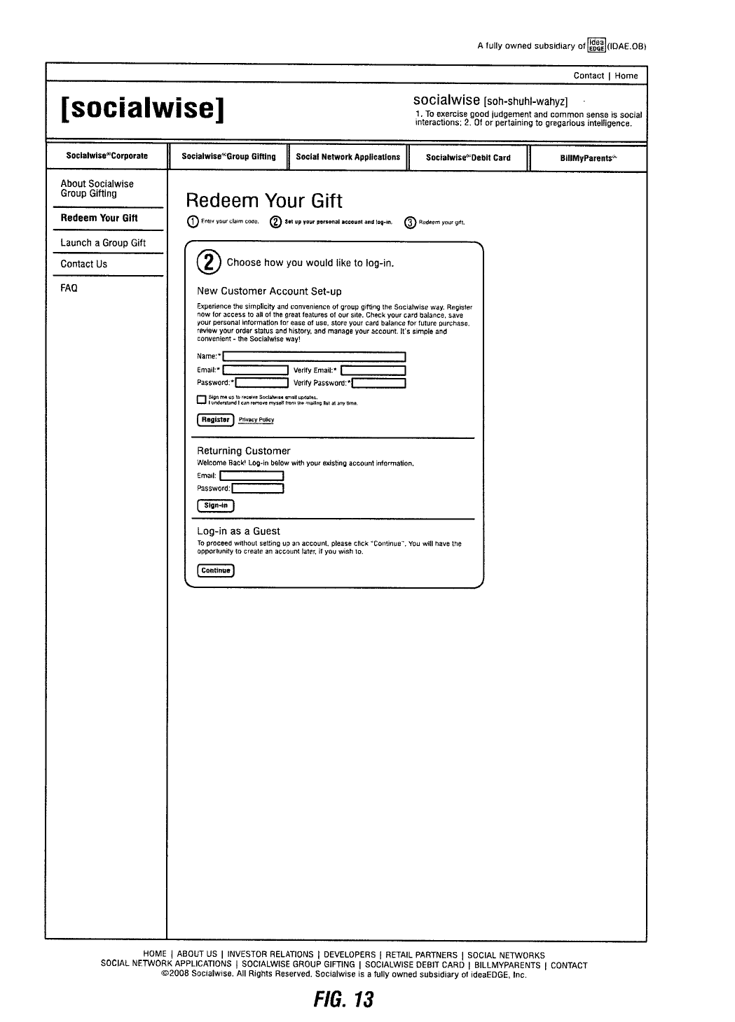

Turning to FIG. 13, in step 2, the administrator is then prompted to set up a personal account and log-in. If the administrator is a new customer to the group gift card site, information such as name, email, and password are recorded. If the administrator is a returning customer, the administrator is prompted to enter email and password information. Alternatively, the administrator may log-in as a guest, without creating an account.

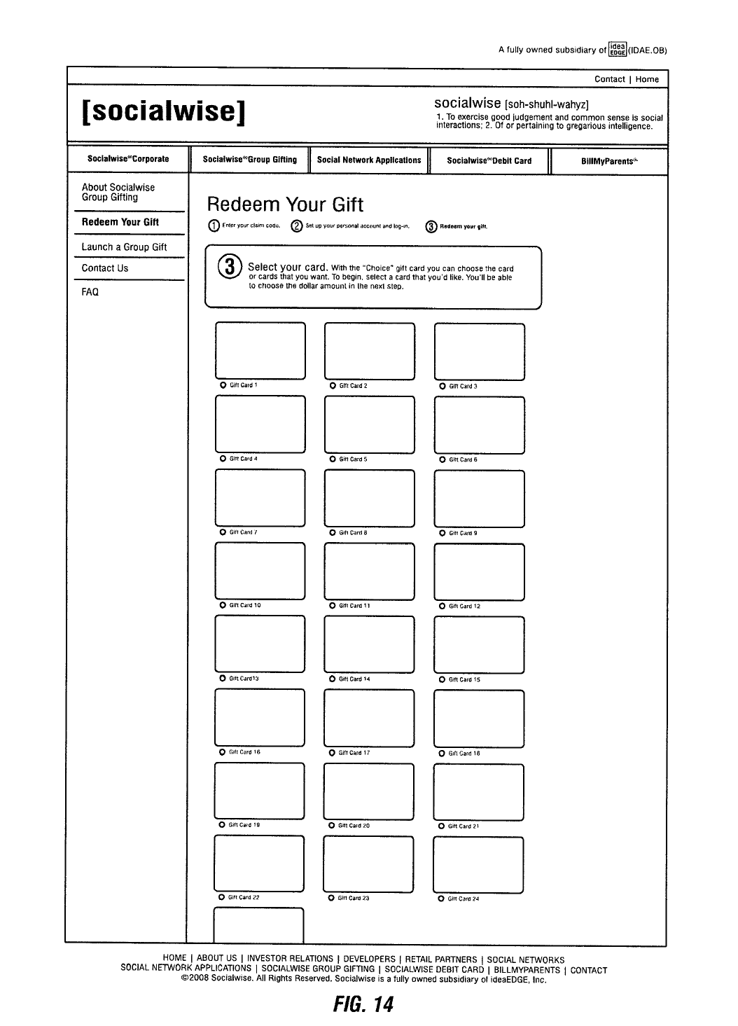

In step 3, and shown in FIGS. 14, 15 and 16, the administrator can select which gift cards and the amount to go on each gift card. The administrator can also select how the card is to be received, e.g. physical or virtual. For physical gift cards, the administrator is prompted to enter shipping information.

As is appreciated, social networking sites such as Facebook require that users log-in to a personal account which contains personal information about the users such as friend lists. A benefit associated with the present system 20 is its ability to utilize this stored data, such as by utilizing the friend lists as a default list for sending information about a group gift card.

Because of the system's 20 capability to use existing functionality of social networking sites, in some embodiments, system 20 stores user data from the social networking site in database 80 (FIG. 4). For example, such stored data may include a user's personal information such as birth date, email address, friend lists, etc. This data may be used at a later time to create a new group gift card. As described above, in some embodiments system 20 can automatically initiate a group gift card. For example, system 20 may scan data stored in database 80 for upcoming birth dates. Upon identifying an upcoming birth date, system 20 may identify the user associated with the birth date and create a group gift card for the user. By default, system will select a “let them choose” gift card, or gift card not associated with a particular retailer. This allows a user to select the type of gift card they prefer when they redeem their gift. System 20 then uses the friend list associated with the user to solicit contributions for the group gift card.

Additionally, in some embodiments, system 20 may provide a translation service between social networks. For example, a user of social networking site 16A may have initiated a group gift card on social networking site 16A. The user may also be member of social networking site 16B. System 20, recognizing that the user is members of both sites 16A, 16B, may present on the user's social networking site 16B that user has initiated a group gift card on social networking site 16A. In this way, system 20 may propagate the group gift card and seek contributions from the friend list associated with site 16B.

In one embodiment of the presently described systems and methods, a site or web page is created in connection with each event. An event generally corresponds to the creation of a gift card to be funded. In one embodiment, the account administration module 32 allows the account administrator to create and personalize that site or web page. For example, a background can be selected or their own designs can be imported, font types can be chosen and photos, clipart and other images can be imported into the site. Further personalized messages and text can be created for the site. Additionally, in some embodiments, the module 32 provides templates and examples which can be utilized and modified.

Those of skill in the art will appreciate that the various illustrative functions, modules and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules and method steps described in connection with the embodiments disclosed herein can be implemented or performed with a general purpose computer such as a server.

Additionally, the steps of a method or algorithm described in connection with the embodiments disclosed herein can be embodied directly in hardware, in a software module executed by a processor, or in a combination of the two. For example, the steps of a method or algorithm described with the embodiments may be stored as a single module or multiple modules on one or more computer readable media or the computer readable media can be comprised of multiple storage elements or systems. A software module can reside in RAM memory, flash memory, ROM memory, EPROM memory, EEPROM memory, registers, hard disk, a removable disk, a CD-ROM, or any other form of computer readable storage media including a network storage medium. An exemplary storage medium can be coupled to the processor of the computer such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments.

What is claimed is:

1. A method for operating a group gift card system in a social networking system, comprising:
initiating a group gift card account;
identifying a first potential contributor list from a first social group list of a personalized data set of the group gift card recipient;
transmitting an electronic communication to a first party on the first social group list via an electronic communication pathway;
prompting the first party to make a financial contribution to the group gift card account;
acquiring a second potential contributor list from a second social group list of a personalized data set of the first party;
transmitting an electronic communication to a second party on the second social group list via an electronic communication pathway;
prompting the second party to make a financial contribution to the group gift card account; and
receiving an electronic payment from at least two parties on the social group lists to fund the group gift card account.

2. The method of claim 1, wherein the group gift card account is initiated by:
creating a group gift account having an account identifier; and
selecting the type of group gift card from a list of gift card providers.

3. The method of claim 1, further comprising:
closing the group gift card account; and
issuing a group gift card from the funds in the closed group gift card account.

4. The method of claim 3, wherein the electronic payment from each of the parties is received in a holding account, allowing the group gift card to be issued in a single funding transaction.

5. The method of claim 2, wherein the group gift card account is initiated by the recipient of the group gift card.

6. The method of claim 2, wherein the group give card account is initiated automatically based on the personalized data set of the recipient of the group gift card.

7. The method of claim 1, further comprising:
storing the personalized data sets of the group gift card recipient and the first party.

8. The method of claim 3, wherein issuing of the gift card comprises:
transmitting an electronic communication to the gift card recipient via an electronic communication pathway, the electronic communication comprising a redemption code for the gift card.

9. The method of claim 3, wherein the gift card account is closed in response to the occurrence of an event.

10. The method of claim 1, further comprising
acquiring a third potential contributor list from a third social group list of a personalized data set of the second party;
transmitting an electronic communication to a third party on the third social group list via an electronic communication pathway; and
prompting the third party to make a financial contribution to the group gift card account.

11. A method for contributing to a group gift card, comprising:
initiating an electronic group gift card account;
soliciting potential contributors from a first potential contributor list to financially contribute to the group gift card account;
receiving a financial contribution from a first contributor to the group gift card account;
soliciting potential contributors from a second potential contributor list to financially contribute to the group gift card; and
receiving a financial contribution from a second contributor to the group gift card account.

12. The method of claim 11, wherein the second contributor is solicited from the first potential contributor list.

13. The method of claim 11, wherein the second contributor is solicited from the second potential contributor list.

14. The method of claim 11, wherein the second potential contributor list is obtained from the first contributor's personalized data on a social networking site.

15. The method of claim 11, wherein the first potential contributor list is obtained from the recipient of the group gift card account's personalized data on a social networking site.

16. The method of claim 11, wherein the potential contributors are solicited by electronic communications requesting that the potential contributors contribute to the group gift card.

17. The method of claim 11, wherein the group give card account is initiated automatically based on personalized data of the recipient of the group gift card.

18. A computer readable media having program code stored thereon that causes a computing system to execute instructions for operating a group gift card system in a social networking system by performing the following steps comprising:
initiating a group gift card account;
identifying a first potential contributor list from a first social group list of a personalized data set of the group gift card recipient;
transmitting an electronic communication to a first party on the first social group list via an electronic communication pathway;
prompting the first party to make a financial contribution to the group gift card account;
acquiring a second potential contributor list from a second social group list of a personalized data set of the first party;
transmitting an electronic communication to a second party on the second social group list via an electronic communication pathway;
prompting the second party to make a financial contribution to the group gift card account; and
receiving an electronic payment from at least two parties on the social group lists to fund the group gift card account.

19. The computer readable medium according to claim 18, wherein the step further comprise:
closing the group gift card account; and
issuing a group gift card from the funds in the closed group gift card account.

20. The computer readable medium according to claim 19, wherein the electronic payment from each of the parties is received in a holding account, allowing the group gift card to be issued in a single funding transaction.
